(19) United States
(12) Patent Application Publication
(10) Pub. No.: US 2025/0252636 A1
(43) Pub. Date: Aug. 7, 2025

(54) SOUND EFFECT DISPLAY METHOD AND TERMINAL DEVICE

(71) Applicant: Beijing Zitiao Network Technology Co., Ltd., Beijing (CN)

(72) Inventor: Shun HU, Beijing (CN)

(21) Appl. No.: 18/695,327

(22) PCT Filed: Sep. 14, 2022
(86) PCT No.: PCT/CN2022/118617

§ 371 Date: Mar. 25, 2024

(30) Foreign Application Priority Data
Oct. 25, 2021 (CN) 202111243078.2

(51) Int. Cl. G06T 13/20; G06F 3/16; G06T 19/20

(52) U.S. Cl. CPC G06T 13/205; G06F 3/165; G06T 19/20; G06T 2200/24; G06T 2219/2012

(57) ABSTRACT

A sound effect display method and terminal device are provided. The method includes receiving a first operation input to a target audio file; in response to the first operation, displaying a sound effect display interface corresponding to the target audio file. The sound effect display interface includes a cover image, a sound wave display element, and a gyroscope; the sound wave display element being an annular surface along an edge of the cover image for expanding an area where the cover image is located according to a preset sound attribute of the target audio file to form an audio waveform corresponding to the preset sound attribute of the target audio file; the gyroscope including at least two light rings rotating along rotational axes thereof in a preset mode, the rotational axes of the at least two light rings being symmetric axes in a plane where the cover image is located.

The present application claims the priority of Chinese Patent Application No. 202111243078.2, entitled “A Method of Displaying Sound Effect and A Terminal Device” filed on Oct. 25, 2021, the entire content of which is incorporated into the present application by reference.

### TECHNICAL FIELD

The present application relates to the field of terminal technology, especially to a method of displaying a sound effect and a terminal device.

### BACKGROUND

With the continuous development of the multimedia technology, users are no longer satisfied only with the status that a playing device can provide an audio or video files restored at high-precision, but put forward a new requirement for the overall feeling on the playing content.

At present, most of audio playing applications (Applications) have focused on the users' listening experience when an audio is played, but overlook the effect of the visual experience of the sound effect display interface on the overall feeling of the audio playing. Because the effect of the visual experience of the sound effect display interface on the overall feeling of the audio playing is not considered, many audio playing applications display a very monotonous image in the display screen of a terminal device in scenes such as playing audio files. For example, some music playing applications always display a static picture associated with the played music on the music player interface when playing songs. However, the visual experience of the sound effect display interface has a very important influence on the overall experience of the audio playing, and thus how to improve the visual experience of the sound effect display interface is also a very important research topic.

### SUMMARY

In light of this, embodiments of the present application provide a method of displaying a sound effect and a terminal device to improve the visual experience of the sound effect display interface.

To achieve the above object, the embodiments of the present application provide the following technical solutions.

In a first aspect, the embodiments of the present application provide a method of displaying a sound effect, comprising: receiving a first operation that is input to a target audio file; and displaying a sound effect display interface corresponding to the target audio file in response to the first operation; the sound effect display interface comprises: a cover image corresponding to the target audio file, a sound wave display element and a quasi-gyroscope; the sound wave display element is an annular surface arranged along an edge of the cover image, which is used to expand to an area where the cover image is located according to a preset sound attribute of the target audio file to form a sound waveform corresponding to the preset sound attribute of the target audio file; the quasi-gyroscope comprises at least two light rings rotating along rotational axes in preset mode, and the rotational axes of the at least two light rings are all symmetric axes located within a plane where the cover image is located, and the rotational axes of the at least two light rings intersect at a geometric center of the cover image.

In a second aspect, the embodiments of the present application provide a terminal device, comprising: a receiving unit configured to receive a first operation that is input to a target audio file; and a display unit configured to display a sound effect display interface corresponding to the target audio file in response to the first operation; the sound effect display interface comprises: a cover image corresponding to the target audio file, a sound wave display element and a quasi-gyroscope; the sound wave display element is an annular surface arranged along an edge of the cover image, which is configured to expand to an area where the cover image is located according to a preset sound attribute of the target audio file to form a sound waveform corresponding to the preset sound attribute of the target audio file; the quasi-gyroscope comprises at least two light rings rotating along rotational axes in a preset mode, and the rotational axes of the at least two light rings are all symmetric axes located within a plane where the cover image is located, and the rotational axes of the at least two light rings intersect at a geometric center of the cover image.

In a third aspect, the embodiments of the present application provide an electronic device, comprising: a memory configured to store a computer program and a processor configured to enable the electronic device to perform the method of displaying the sound effect described in any one of the embodiments upon calling the computer program.

In a fourth aspect, the embodiments of the present application provide a computer-readable storage medium, the computer-readable storage medium has a computer program stored thereon, and the computer program enables a computing device to perform the method of displaying the sound effect described in any one of the embodiments upon the computer program being executed by the computing device.

In a fifth aspect, the embodiments of the present application provide a computer program product, which enables a computer to perform the method of displaying a sound effect described in any one of the embodiments upon the computer program product being executed in the computer.

The method of displaying a sound effect provided in the embodiments of the present application displays a sound effect display interface corresponding to the target audio file in response to the first operation upon receipt of a first operation that is input to a target audio file. The sound effect display interface comprises: a cover image corresponding to the target audio file, a sound wave display element and a quasi-gyroscope; the sound wave display element is an annular surface arranged along an edge of the cover image, which is configured to expand to an area where the cover image is located according to a preset sound attribute of the target audio file to form a sound waveform corresponding to the preset sound attribute of the target audio file; the quasi-gyroscope comprises at least two light rings rotating along rotational axes in a preset mode, and the rotational axes of the at least two light rings are all symmetric axes located within a plane where the cover image is located, and the rotational axes of the at least two light rings intersect at a geometric center of the cover image. Thus, a three-dimensional sound effect display interface generated by a cover image, a sound wave display element and a quasi-gyroscope in the embodiments of the present application can allow the sound effect display interface to have spatial and three-dimensional senses, thereby improving the visual experience of the sound effect interface when the audio is played.

### BRIEF DESCRIPTION OF THE DRAWINGS

The accompanying drawings herein are incorporated into and constitute a part of this specification, which illustrate the embodiments in conformity with the present application and serve to explain the principles of the present application together with the description.

To illustrate the technical solutions in embodiments of the present application or the related art more clearly, the accompanying drawings which are required to describe the embodiments or the related art will be briefly described below. Apparently, for one of ordinary skill in the art, other drawings can be obtained on the basis of these drawings without any creative work.

FIG. 1 is a flowchart of a method of displaying a sound effect provided in an embodiment of the present application;

FIG. 2 is a first schematic diagram of the sound effect interface provided in an embodiment of the present application;

FIG. 3 is a first schematic diagram of a layer structure of the sound effect interface provided in the embodiment of the present application;

FIG. 4 is a second schematic diagram of the layer structure of the sound effect interface provided in the embodiment of the present application;

FIG. 5 is a schematic diagram of a deflected angle of the sound effect interface provided in an embodiment of the present application;

FIG. 6 is a schematic diagram of deflection of sound effect interface provided in the embodiment of the present application;

FIG. 7 is a third schematic diagram of the layer structure of the sound effect interface provided in the embodiment of the present application;

FIG. 8 is a second schematic diagram of the sound effect interface provided in the embodiment of the present application;

FIG. 9 is a schematic diagram of the sound wave display element provided in the embodiment of the present application;

FIG. 10 is a structural schematic diagram of a terminal device provided in an embodiment of the present application; and

FIG. 11 is a schematic diagram of hardware structure of an electronic device provided in an embodiment of the present application.

### DETAILED DESCRIPTION

To understand the above objects, features, and advantages more clearly, the solutions of the present application will be further described below. It is to be noted that, without conflicting with each other, the embodiments and features in embodiments of the present application can be combined with each other.

Many particular details are set forth in the following description to sufficiently understand the present application, but the present application can be implemented by other ways than those described herein. Obviously, the embodiments in the description are merely some, not all embodiments of the present application.

In the embodiments of the present application, the terms like “exemplary” or “for example/such as”, etc. are used to represent an example, exemplary illustration, or explanation. Any embodiment or design described as being “exemplary” or “for example/such as” should not be construed to be more preferable or advantageous over other embodiments or designs. Specifically, the use of the terms “exemplary” or “fox example/such as” is intended to present an associated concept in a specific manner. In addition, in the description of the embodiments of the present application, “a plurality of/multiple” refers to two or more, unless otherwise specified.

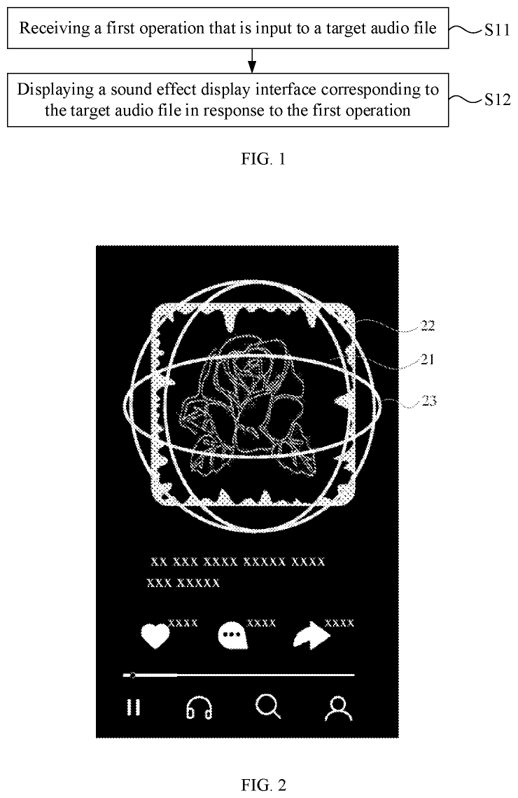

Based on the above contents, the embodiments of the present application provide a method of displaying a sound effect. Referring to FIG. 1, the method of displaying a sound effect comprises the following steps.

S11. Receiving a First Operation that is Input to a Target Audio File.

The first operation in the embodiments of the present application can be either an operation used to trigger the playing of the target audio file, or an operation used to share the target audio file, or an operation used to generate and pre-view a sound effect display interface of the target audio file. The first operation can specifically be a click operation to target audio file, or a voice command, or a specific gesture. In some embodiments of the present application, the specific gesture can be any one of click gesture, sliding gesture, pressure identification gesture, long-press gesture, area-changing gesture, double-press gesture, and double-click gesture.

The target audio file in the embodiments of the present application can be any type of audio files. For example, songs, audiobooks, accompaniment music, or the like.

### S12. Displaying the Sound Effect Display Interface Corresponding to the Target Audio File in Response to the First Operation.

The sound effect display interface comprises: a cover image corresponding to the target audio file, a sound wave display element and a quasi-gyroscope; the sound wave display element is an annular surface arranged along an edge of the cover image, which is configured to expand to an area where the cover image is located according to a preset sound attribute of the target audio file to form a sound waveform corresponding to the preset sound attribute of the target audio file; the quasi-gyroscope comprises at least two light rings rotating along rotational axes in a preset mode, and the rotational axes of the at least two light rings are all symmetric axes located within a plane where the cover image is located, and the rotational axes of the at least two light rings intersect at a geometric center of the cover image.

In some implementations, the preset sound attribute of the target audio file in the embodiments of the present application can be a loudness, a tone output by the target audio file or the like, which is not limited in the embodiments of the present application.

Further, the implementation of the sound wave display element expanding according to the preset sound attribute of the target audio file to the area where the cover image is located to form the sound waveform corresponding to the preset sound attribute of the target audio file can comprise: periodically sampling the audio frames of the target audio file with a preset time length as period to acquire key audio frames of the target audio file, extracting the preset sound attribute of various key audio frames, and controlling the sound wave display element to expand to the area where the cover image is located according to the preset sound attribute of the various key audio frames to form the sound wave form corresponding to the preset sound attribute of the target audio file. For example, the preset time length can be a time length for playing 2 audio frames. That is, the key audio frames are sampled at every 2 audio frames.

It is to be noted that the sound effect display interfaces are different display interfaces of the target audio file when the first operations are different operations to the target audio file. For example, the sound effect display interface can be a player interface of the target audio file when the first operation is a play operation input to the target audio file. As another example, the sound effect display interface can be a shared pre-view interface of the target audio file when the first operation is a sharing operation input to the target audio file.

For example, referring to FIG. 2, the sound effect display interface comprises: a cover image 21 corresponding to the target audio file, a sound wave display element 22 and a quasi-gyroscope 23; the sound wave display element 22 is an annular surface arranged along an edge of the cover image, which is configured to expand to an area where the cover image is located according to a preset sound attribute of the target audio file to form a sound waveform corresponding to the a preset sound attribute of the target audio file. The quasi-gyroscope 23 comprises three light rings rotating along rotational axes in preset mode, the rotational axes of all the three circular light rings are located in diameters within the plane where the cover image 21 is located, and the centers of all the three circular light rings are located at the geometric center of the cover image 21.

It is to be noted that FIG. 2 is shown by using a quasi-gyroscope 23 comprising three circular light rings as example, but the embodiments of the present application is not limited thereto. Based on the above embodiments, the quasi-gyroscope 23 in the embodiments of the present application can also comprise other number of light rings in other shape. For example, the quasi-gyroscope 23 can comprise two circular light rings. As another example, the quasi-gyroscope 23 can comprise four circular light rings. As yet another example, the quasi-gyroscope 23 can comprise three rectangular light rings.

It is also to be noted that FIG. 2 is shown by using the cover image 21 as a rectangular image and the sound wave display element 22 arranged along the edge of the cover image 21 as a rectangular annular surface as example, but the embodiments of the present application is not limited thereto. Based on the above embodiments, the cover image 21 in the embodiments of the present application can also be an image in other shape, e.g., circle, hexagon, octagon, irregular shape, or the like, and the corresponding sound wave display element 22 can also be an annular surface in other shapes.

The method of displaying a sound effect provided in the embodiments of the present application displays a sound effect display interface corresponding to the target audio file in response to the first operation upon receipt of a first operation input to a target audio file. The sound effect display interface comprises: a cover image corresponding to the target audio file, a sound wave display element and a quasi-gyroscope; the sound wave display element is an annular surface arranged along an edge of the cover image, which is configured to expand to an area where the cover image is located according to a preset sound attribute of the target audio file to form a sound waveform corresponding to the preset sound attribute of the target audio file; the quasi-gyroscope comprises at least two light rings rotating along rotational axes in a preset mode, and the rotational axes of the at least two light rings are all symmetric axes located within a plane where the cover image is located, and the rotational axes of the at least two light rings intersect at a geometric center of the cover image. Thus, a three-dimensional sound effect display interface generated by a cover image, a sound wave display element and a quasi-gyroscope in the embodiments of the present application can allow the sound effect display interface to have spatial and three-dimensional senses, thereby improving the visual experience of the sound effect interface when the audio is played.

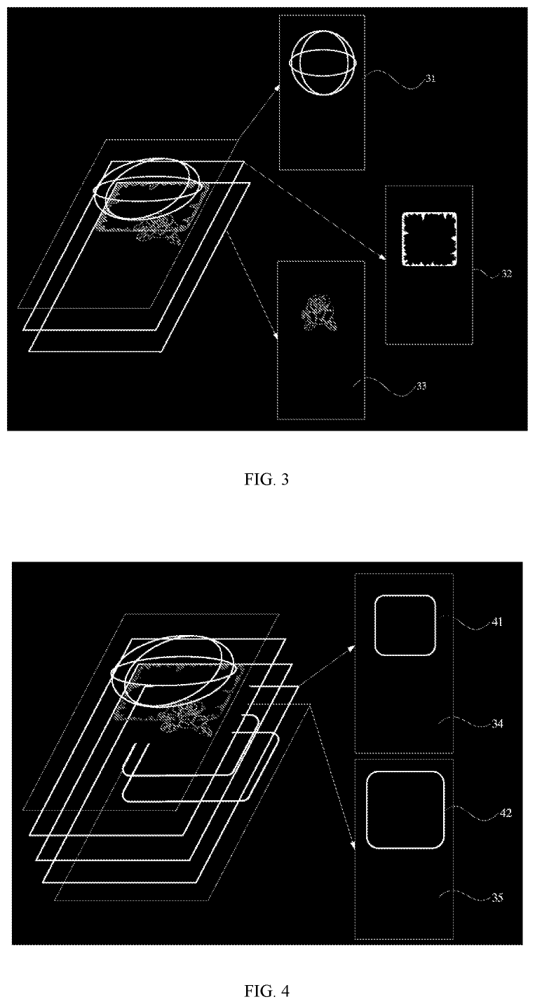

In some implementations, referring to FIG. 3, the quasi-gyroscope is displayed on the first layer 31 of the sound effect display interface, the sound wave display element is displayed on the second layer 32 of the sound effect display interface, and the cover image is displayed on the third layer 33 of the sound effect display interface; and the first layer 31 is located on the second layer 32, and the second layer 32 is located on the third layer 33.

Because the first layer 31 of displaying the quasi-gyroscope is located on the second layer 32 displaying a sound wave display element, the above embodiments can allow the quasi-gyroscope in the sound effect display interface to be displayed covering on the sound wave display element. Moreover, because the second layer 32 displaying a sound wave display element is located on the third layer 33 of displaying the cover image, the above embodiments can also enable the sound wave display element on the sound effect display interface to be displayed covering on the cover image.

In some implementations, the method further comprises: fuzzifying the sound wave display element.

For example, the implementation of fuzzifying the sound wave display element can comprise: treating the imaged displayed on the second layer by Gaussian blur to set the color values of various pixels in the second layer as an average color value of various pixels in a preset neighborhood scope. In some embodiments, the preset neighborhood scope can be one comprising 40 pixels.

In some implementations, the displaying the sound effect display interface corresponding to the target audio file in the above step S12 comprising the following step a and step b.

Step a. Generating a First Sequence of Frames Corresponding to the Quasi-Gyroscope.

The rotation positions of the light rings in various image frames in the first sequences of frames vary sequentially.

Step b. Playing Circularly the First Sequence of Frames on the First Layer to Display the Sound Effect Display Interface Corresponding to the Target Audio File.

The above embodiment displays the quasi-gyroscope in the sound effect display interface by a sequence of frames. Therefore, as compared with the sound effect display interface obtained by implementing a rendering quasi-gyroscope, the embodiments of the application can avoid the use of a particle effect animation engine while achieving a dynamic effect of the quasi-gyroscope, thereby reducing the data processing amount of a rendering sound effect display interface and avoiding a terminal equipment with poor performance from failing to normally display the sound effect display interface of the embodiments of the application.

In some implementations, referring to FIG. 4, the sound effect display interface further comprises: a fourth layer 34 under the third layer 33 and a fifth layer 35 under the fourth layer 34.

The fourth layer 34 is configured to display a border of the first pattern 41, and the fifth layer 35 is configured to display a border of the second pattern 42. Both the first pattern 41 and the second pattern 42 are similar patterns to the cover image 21, and the geometric centers of the first pattern 41 and the second pattern 42 and the geometric center of the cover image 21 are located at the same point, the area of the first pattern 41 is greater than the area of the cover image 21, and the area of the second pattern 42 is greater than the area of the first pattern 41.

Because the sound effect display interface of the above embodiments further comprise the borders of the first pattern 41 and the second pattern 42, the above embodiments can further create a spatial sense of the sound effect display interface via the borders of the first pattern 41 and the second pattern 42, thereby further improving the visual experience of the sound effect display interface.

In some implementations, the method of displaying a sound effect provided in the embodiments of the present application further comprises fuzzifying the borders of the first pattern and the border of the second pattern.

Also, it is possible to subject the fourth layer and the fifth layer to Gaussian Blur to fuzzify the border of the first pattern and the border of the second pattern.

In some implementations, the method of displaying a sound effect provided in the embodiments of the present application further comprises the following step a and step b.

Step a. Acquiring a Deflection Angle of the Sound Effect Display Interface.

The deflection angle is an angle between a direction perpendicular to the sound effect display interface and a gravity direction.

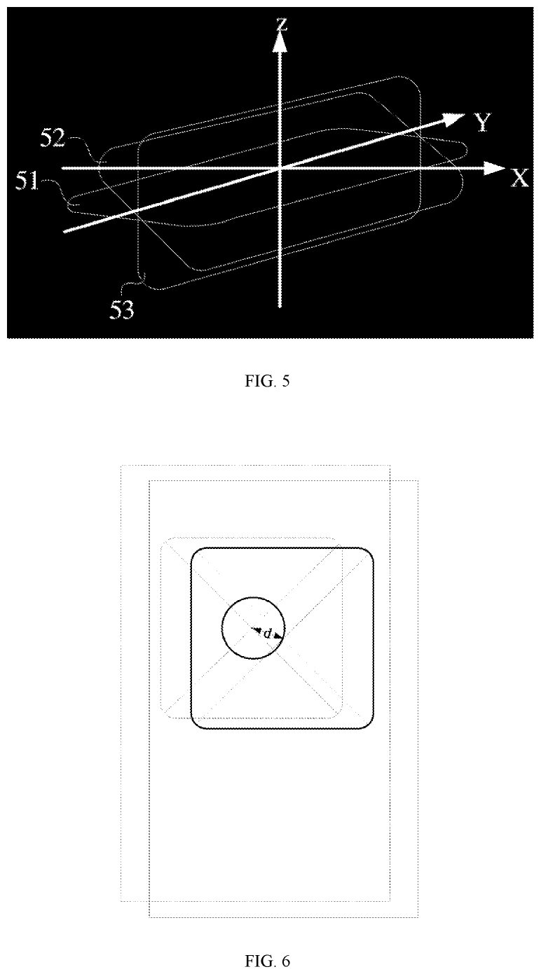

For example, referring to FIG. 5, FIG. 5 is shown by taking the gravity direction in the same line of the z-axis direction as example. An angle of the direction perpendicular to the sound effect display interface 51 and the gravity direction is zero degree, so that the sound effect display interface 52 has a deflection angle of 0 degree. An angle of the direction perpendicular to the sound effect display interface 52 and the gravity direction is 45°, so that the sound effect display interface 52 has a deflection angle of 45°. An angle of the direction perpendicular to the sound effect display interface 53 and the gravity direction is 90°, so that the sound effect display interface 53 has a deflection angle of 90°.

Step b. Controlling the First Layer, the Second Layer, the Third Layer, the Fourth Layer, and the Fifth Layer to Deflect in Corresponding Deflection Ranges According to the Deflection Angle, Respectively.

In some implementations, the corresponding deflection range to the first layer (the layer displaying the quasi-gyroscope) and the third layer (the layer displaying the cover image) is [0 ps, 30 ps], the corresponding deflection range to the second layer (the layer displaying the sound wave display element) is [0 ps, 27 ps], the corresponding deflection range to the fourth layer (the layer displaying the border of the first image) is [0 ps, 20 ps], and the corresponding deflection range to the fifth layer (displaying the border of the second image) is [0 ps, 11 ps].

Further, the controlling the first layer, the second layer, the third layer, the fourth layer and the fifth layer to deflect in the corresponding deflection ranges according to the deflection angle respectively can comprise following steps.

Controlling the first layer, the second layer, the third layer, the fourth layer, and the fifth layer to deflect a distance of 0 when the deflection angle is 0°;

Controlling the first layer, the second layer, the third layer, the fourth layer, and the fifth layer to deflect a distance positively correlated with the deflection angle when the deflection angle belongs to (0°, 45°);

Controlling the first layer, the second layer, the third layer, the fourth layer, and the fifth layer to deflect a distance equal to the maximum values of the corresponding deflection ranges, respectively, when the deflection angle is 45°;

Controlling the first layer, the second layer, the third layer, the fourth layer, and the fifth layer to deflect a distance be kept as the maximum values of the corresponding deflection ranges, respectively, when the deflection angle is (45°, 90° ].

For example, referring to FIG. 6, the above embodiments are described by using the deflection effect of the third layer as example in FIG. 6. When the corresponding deflection range to the third layer is [0, d], the geometric center of the cover image displayed on the third layer will move within a circle with radius d where the geometric center of the cover image is located when the center of the circle is located at an initial position.

The method of displaying a sound effect provided in the above embodiment further comprises: acquiring the deflection angle of the sound effect display interface, and controlling the first layer, the second layer, the third layer, the fourth layer, and the fifth layer to deflect in the corresponding deflection ranges according to the deflection angles. Thus, the above embodiment can allow the quasi-gyroscope, the sound wave display element, the cover image, the border of the first pattern, and the border of the second pattern to deflect with the deflection of the sound effect display interface, thereby further improving the spatial sense of the sound effect display interface.

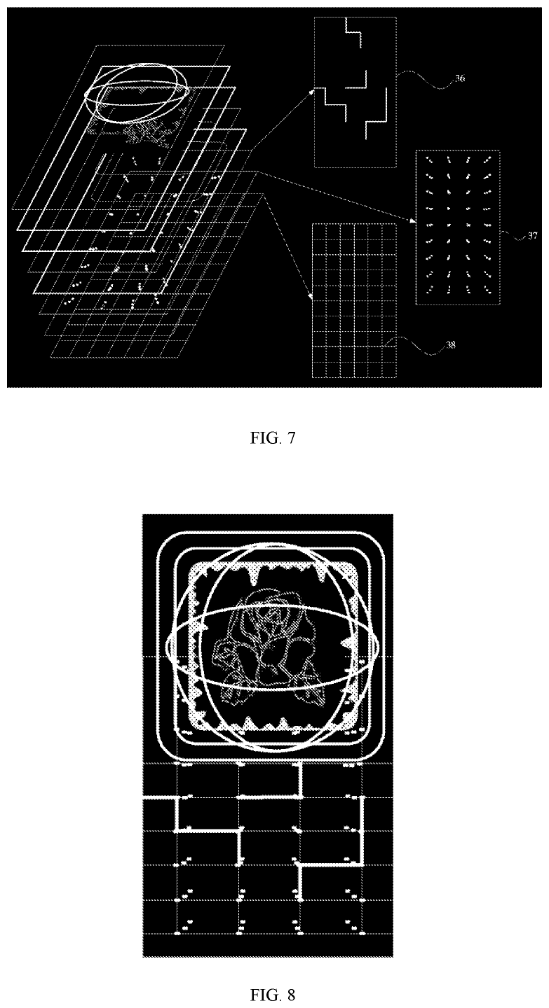

In some implementations, referring to FIG. 7 and FIG. 8, the sound effect display interface further comprises: a sixth layer 36 under the fifth layer 35, a seventh layer 37 under the sixth layer 36, and an eighth layer 38 under the seventh layer 37.

The sixth layer 36 is configured to display a dot matrix image, the seventh layer 37 is configured to display streamer image, and the eighth layer 38 is configured to display a grid image, wherein the dot matrix image is a projection image of a three-dimensional matrix; the streamer image comprises a plurality of streamer lines propagating along edges of grids in the grid image, and the grid image comprises grids formed by the intersection of a plurality of horizontal lines and a plurality of vertical lines.

The sound effect display interface provided by the above embodiment further comprises: a dot matrix image displayed on the sixth layer, a streamer image displayed on the seventh layer and a grid image displayed on the eighth layer, and thus the above embodiments can enhance the spatial and three-dimensional senses of the sound effect display interface via the dot matrix image, the streamer image, and the grid image, thereby further improving the visual experience of the sound effect display interface.

In some implementations, the method of displaying a sound effect provided in the embodiments of the present application further comprises the following step I and step II.

### Step I. Generating a Second Sequence of Frames Corresponding to the Streamer Image.

The positions of the streamer lines in various image frames in the second sequences of frames vary sequentially.

### Step II. Playing Circularly the Second Sequence of Frames on the Seventh Layer to Display the Sound Effect Display Interface Corresponding to the Target Audio File.

The above embodiment displays the streamer image in the sound effect display interface by a sequence of frames. Therefore, as compared with the sound effect display interface obtained by implementing a rendering streamer image, the embodiments of the application can avoid the use of a particle effect animation engine while achieving a dynamic effect of the streamer image, thereby reducing the data processing amount of a rendering sound effect display interface and avoiding a terminal equipment with poor performance from failing to normally display the sound effect display interface of the embodiments of the application.

In some implementations, a color in a first position of the sound wave display element is a first color, and a color in a second position of the sound wave display element is a second color; a color of the sound wave display element varies gradually from the first color to the second color between the first position and the second position of the sound wave display element.

In some implementations, the first position and the second position are two respective intersection positions of a target line and the sound wave display element; the target line is a line in a first plane, which passes through the geometric center of the sound wave display element and has a preset angle with a horizontal direction. For example, the preset angle can be 45°.

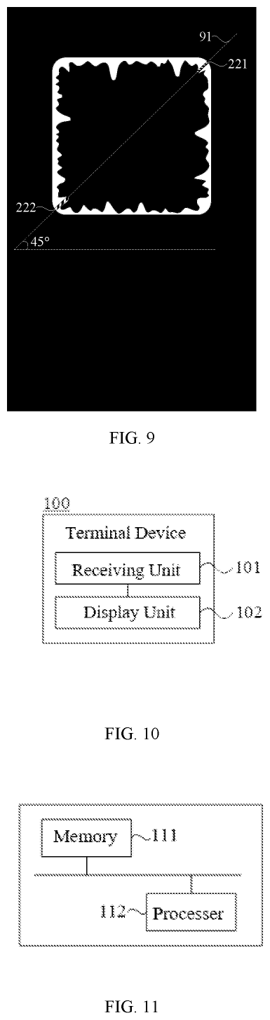

Referring to FIG. 9, the target line 91 and the sound wave display element have two intersection points of point 221 and point 222. Thus, the point 221 and the point 222 are the first and the second positions of the sound wave display element, respectively, the color of the point 221 and the color of the point 222 are the first color and the second color, respectively, and the color from the point 221 to the point 222 of the sound wave display element 22 varies gradually from the first color to the second color.

In some implementations, the method of displaying a sound effect provided in the embodiments of the present application further comprises determining the first color, the second color, and the background color of the sound effect display interface according to the color of the cover image, prior to the above step S12 (displaying the sound effect display interface corresponding to the target audio file).

In some implementations, the implementation of determining the first color, the second color, and the background color of the sound effect display interface according to the color of the cover image can comprise the following step 1 to step 3.

### Step 1: Acquiring an Average Color Value of Various Pixels of the Cover Image.

That is, acquiring color values of various pixels in the cover image, and dividing the sum of the color values of the various pixels by the number of the pixels in the cover image to obtain the average color value of the various pixels in the cover image.

Step 2: Converting the Average Color Value into a Color in an HSV Color Space to Obtain a Basic Color.

Specifically, the HSV color space is a color space representing colors by hue (Hue), saturation (Saturation) and brightness (Value), in which any color in the HSV color space comprises a parameter H used to represent the hue, a parameter S used to represent the saturation, and a parameter V used to represent the value.

Colors in different color spaces have specific conversion formula, and thus it is possible to determine the conversion formula according to the color space to which the cover image belongs, and then converting the average color value in accordance with the determined conversion formula to give a basic color. For example, if the cover image belong to the RGB color space, the average color value will be converted according to the conversion formula between the RGB color space and the HSV color space to obtain a basic color.

### Step 3: Determining the First Color, the Second Color, and a Background Color of the Sound Effect Display Interface.

In some implementations, the determining the first color according to the basic color comprises: determining that a hue of the first color is the same as a hue of the basic color; determining that a saturation of the first color is the same as a saturation of the basic color if the saturation of the basic color is greater than or equal to a threshold saturation; and determining that the saturation of the first color is a sum of the saturation of the basic color and a preset saturation if the saturation of the basic color is less than the threshold saturation; and determining a value of the first color is the maximum value.

Given: the value, the saturation, the value of the basic color are H₀, S₀, and V₀, respectively, and the value, the saturation, and the value of the first color are H₁, S₁, and V₁, respectively, the threshold saturation is S_{threshold}, the preset saturation is a, then:

$${H}_{1} = {H}_{0}$$

$${S}_{1} = \{ \begin{matrix}{S}_{0} & {S}_{0} \geq {S}_{threshold} \\ {S}_{0} + a & {S}_{0} < {S}_{threshold}\end{matrix}$$

$${V}_{1} = 100$$

In some implementations, the determining the second color according to the basic color comprises: determining that a hue of the second color is a sum of a hue of the basic color and a preset hue; determining that a saturation of the second color is the same as a saturation of the basic color if the saturation of the basic color is greater than or equal to a threshold saturation; and determining that the saturation of the second color is a sum of the saturation of the basic color and a preset saturation if the saturation of the basic color is less than the threshold saturation; and determining a value of the second color as a maximum value.

Given: the value, saturation, value of the basic color are H₀, S₀, and V₀, respectively, and the value, the saturation, and the value of the second color are H₂, S₂, and V₂, respectively, the threshold saturation is S_{threshold}, the preset saturation is a, the preset hue is b, then:

$${H}_{2} = {H}_{0} + b$$

$${S}_{2} = \{ \begin{matrix}{S}_{0} {S}_{0} \geq {S}_{threshold} \\ {S}_{0} + {aS}_{0} < {S}_{threshold}\end{matrix}$$

$${V}_{2} = 100$$

In some implementations, the determining the background color according to the basic color comprises: determining that a hue of the background color is the same as a hue of the basic color; determining that a saturation of the background color is the same as a saturation of the basic color if the saturation of the basic color is greater than or equal to a threshold saturation; and determining that the saturation of the background color is a sum of the saturation of the basic color and a preset saturation if the saturation of the basic color is less than the threshold saturation; and determining a value of the background color is a difference between a value of the basic color and a target value, in which the target value is a value corresponding to a value range to which the value of the basic color belongs, and the value corresponding to the value range is positively correlated with the central value of the value range.

For example, the correspondence relationship between the value range and the value can be shown in Table 1 below:

TABLE 1

| Value Range | Corresponding Value |
|---|---|
| [100, 90] | 55 |
| [90, 80] | 50 |
| [80, 70] | 45 |
| [70, 60] | 40 |
| [60, 50] | 35 |
| [50, 40] | 30 |
| [40, 30] | 25 |
| [30, 25] | 20 |
| [25, 20] | 15 |
| [20, 15] | 10 |
| [15, 10] | 7 |
| [10, 5] | 3 |
| [5, 0] | 2 |

Given: the value, the saturation, the value of the basic color are H₀, S₀, and V₀, respectively, and the value, the saturation, and the value of the background color are H₃, S₃, and V₃, respectively, the threshold saturation is S_{threshold}, the preset saturation is a, the correspondence relationship between the value range and the value is as shown in Table 1 above, then:

$${H}_{3} = {H}_{0}$$

$${S}_{3} = \{ \begin{matrix}{S}_{0} {S}_{0} \geq {S}_{threshold} \\ {S}_{0} + a {S}_{0} < {S}_{threshold}\end{matrix}$$

$${V}_{3} = {V}_{0} - c$$

where, when 100≥V₀≥90, c=55; when 90>V₀≥80, c=50; when 80>V₀≥70, c=45; when 70>V₀≥60, c=40; when 60>V₀≥50, c=35; when 50>V₀≥40, c=30; when 40>V₀≥30, c=25; when 30>V₀≥25, c=20; when 25>V₀≥20, c=15; when 20>V₀≥15, c=15; when 15>V₀≥10, c=7; when 10>V₀≥5, c=3; and when 5>V₀≥0, c=2.

Because the above embodiment can determine the first color, the second color and the background color in the sound effect display interface according to the cover image of the audio file, the embodiments of the present application can make the color of the sound effect display interface more correlatively matching the cover image, thereby improving the user's visual experience.

Based on the same invention concept, as an implementation of the above method, the embodiments of the present application also provide a terminal device, and the device embodiment corresponds to the above method embodiment. For convenience of reading, this device embodiment will not reiterate the details of the above method embodiment one by one, but it should be clear that the terminal device in the embodiment can correspond to the entire content of the above method embodiment.

The embodiments of the present application provide a terminal device. FIG. 10 is a structural schematic diagram. As shown in FIG. 10, the terminal device 100 comprises: a receiving unit 101 configured to receive a first operation that is input to a target audio file; and a display unit 102 configured to display a sound effect display interface corresponding to the target audio file in response to the first operation; the sound effect display interface comprises: a cover image corresponding to the target audio file, a sound wave display element and a quasi-gyroscope; the sound wave display element is an annular surface arranged along an edge of the cover image, which is configured to expand to an area where the cover image is located according to a preset sound attribute of the target audio file to form a sound waveform corresponding to the preset sound attribute of the target audio file; the quasi-gyroscope comprises at least two light rings rotating along rotational axes in a preset mode, and the rotational axes of the at least two light rings are all symmetric axes located within a plane where the cover image is located, and the rotational axes of the at least two light rings intersect at a geometric center of the cover image.

In some implementations, the quasi-gyroscope is displayed on the first layer of the sound effect display interface, the sound wave display element is displayed on the second layer of the sound effect display interface, and the cover image is displayed on the third layer of the sound effect display interface; and the first layer is located on the second layer, and the second layer is located on the third layer.

In some implementations, the display unit 102 is further configured to fuzzify the sound wave display element.

In some implementations, the display unit 102 is specifically configured to generate a first sequence of frames corresponding to the quasi-gyroscope, the rotation positions of the light rings in various image frames in the first sequences of frames vary sequentially; and circularly display the first sequence of frames on the first layer to display the sound wave display interface corresponding to the target audio file.

In some implementations, the sound effect display interface further comprises: a fourth layer under the third layer and a fifth layer under the fourth layer; the fourth layer is configured to display a border of a first pattern, the fifth layer is configured to display a border of a second pattern; both the first pattern and the second pattern are similar patterns to the cover image, and the geometric centers of the first pattern and the second pattern and the geometric center of the cover image are located at the same point, the area of the first pattern is greater than the area of the cover image, and the area of the second pattern is greater than the area of the first pattern.

In some implementations, the display unit 102 is further configured to fuzzify the border of the first pattern and the border of the second pattern.

In some implementations, the display unit is configured to acquire a deflection angle of the sound effect display interface which is an angle between a direction perpendicular to the sound effect display interface and a gravity direction; and controlling the first layer, the second layer, the third layer, the fourth layer, and the fifth layer to deflect in corresponding deflection ranges according to the deflection angle, respectively.

In some implementations, the sound effect display interface further comprises: a sixth layer under the fifth layer, a seventh layer under the sixth layer, and an eighth layer under the seventh layer; the sixth layer is configured to display a dot matrix image, the seventh layer is configured to display streamer image, the eighth layer is configured to display a grid image, the dot matrix image is a projection image of a three-dimensional matrix; the streamer image comprises a plurality of streamer lines propagating along edges of grids in the grid image, and the grid image comprises grids formed by the intersection of a plurality of horizontal lines and a plurality of vertical lines.

In some implementations, the display unit 102 is specifically configured to generate a second sequence of frames corresponding to the streamer image, the positions of the streamer lines in various image frames in the second sequences of frames vary sequentially; and circularly display the second sequence of frames on the seventh layer to display the sound wave display interface corresponding to the target audio file.

In some implementations, a color in a first position of the sound wave display element is a first color, and a color in a second position of the sound wave display element is a second color; the color of the sound wave display element varies gradually from the first color to the second color between the first position and the second position of the sound wave display element.

In some implementations, the display unit 102 is further configured to acquire an average color value of various pixels of the cover image before displaying the sound effect display interface corresponding to the target audio file; converting the average color value to a color in the HSV color space to acquire a basic color; and determining the first color, the second color, and the background color of the sound effect display interface according to the basic color.

In some implementations, the display unit 102 is specifically configured to determining that the hue of the first color is the same as that of the basic color; determining that a saturation of the first color is the same as a saturation of the basic color if the saturation of the basic color is greater than or equal to a threshold saturation; and determining that the saturation of the first color is a sum of the saturation of the basic color and a preset saturation if the saturation of the basic color is less than the threshold saturation; and determining that the value of the first color is the maximum value.

In some implementations, the display unit 102 is specifically configured to determining that the hue of the second color is a sum of the hue of the basic color and a preset hue; determining that a saturation of the second color is the same as a saturation of the basic color if the saturation of the basic color is greater than or equal to a threshold saturation; and determining that the saturation of the second color is a sum of the saturation of the basic color and a preset saturation if a saturation of the basic color is less than the threshold saturation; and determining that the value of the second color is the maximum value.

In some implementations, the display unit 102 is specifically configured to determining that the hue of the background color is the same as the hue of the basic color; determining that a saturation of the background color is the same as the saturation of the basic color if the saturation of the basic color is greater than or equal to a threshold saturation; and determining that the saturation of the background color is a sum of the saturation of the basic color and a preset saturation if a saturation of the basic color is less than the threshold saturation; and determining that the value of the background color is a difference between the value of the basic color and the target value, the target value is a value corresponding to the value range to which the value of the basic color belongs, and the value corresponding to the value range is positively correlated with the central value of the value range.

In some implementations, the first position and the second position are two respective intersection positions of a target line and the sound wave display element; the target line is a line in a first plane which passes through the geometric center of the sound wave display element and has a preset angle with a horizontal direction.

The terminal device provided in this embodiment can perform the method of displaying a sound effect provided in the above embodiments. Their implementation principles and technical effects are similar and thus not reiterated herein.

Based on the same invention concept, the embodiments the present application also provide a computer device. FIG. 11 is a structural schematic diagram of an electronic device provided in the embodiments of the present application. As shown in FIG. 11, the electronic device provided in the embodiment comprises: a memory 111 configured to store a computer program and a processor 112 configured to enable the electronic device to perform the method of displaying a sound effect described in any one of provided embodiments upon calling the computer program.

The embodiments of the present application also provide a computer-readable storage medium having a computer program stored thereon, the computer program enables a computing device to perform the method of displaying a sound effect described in the above embodiment upon the computer program being executed by the computing device.

The embodiments of the present application also provide a computer program product, which enables the computer to perform the method of displaying a sound effect described in the above embodiment upon the computer program product being executed in the computer.

It is to be understood by those skilled in the art that embodiments of the present application may be provided as a method, a system, or a computer program product. Therefore, the present application may be in a form of an entirely hardware embodiment, an entirely software embodiment, or an embodiment combining software aspect and hardware aspect. Furthermore, the present application may be in a form of a computer program product embodied on one or more computer usable storage mediums having computer usable program codes included therein.

The processor can be a central processing unit (CPU), and can also be other general processors, a digital signal processor (DSP), an application specific integrated circuit (ASIC), a field-programmable gate array (FPGA) or other programmable logic devices, a discrete gate or a transistor logic device, a discrete hardware component or the like. The general processor can be a microprocessor, or the processor can also be any conventional processor or the like.

The memory may include the form of a non-permanent memory, a random-access memory (RAM) and/or a non-volatile memory in a computer-readable medium, such as a read-only memory (ROM) or a flash memory (flash RAM). The memory is an example of the computer-readable medium.

The computer-readable medium includes a permanent or non-permanent, removable or non-removable storage medium. The storage medium can store information by any method or technology, and the information can be computer-readable instructions, data structures, program modules or other data. Examples of the storage medium for computers include, but are not limited to, phase-change memory (PRAM), static random access memory (SRAM), dynamic random access memory (DRAM), other types of random access memory (RAM), read-only memory (ROM), electrically erasable programmable read-only memory (EEPROM), flash memory or other memory technologies, read-only compact disc read-only memory (CD-ROM), digital versatile disc (DVD) or other optical storage, magnetic cassette, magnetic disk storage or other magnetic storage devices or any other non-transmission medium, which can be used for storing information accessible by a computing apparatus. According to the definition in the present application, the computer-readable medium does not include temporary storage of computer readable media (transitory media), such as modulated data signals and carrier waves.

Finally, it is to be noted that the above embodiments are only used to illustrate, not restrict the technical solutions of the present application. Although the present application is described in detail with reference to the above embodiments, it should be understood for one of ordinary skill in the art that it is still possible to make modification to the technical solutions recorded in the above embodiments, or make equivalent substitution to some or all of the technical features therein, and such modifications or substitutions will not make the nature of the corresponding technical solutions depart from the scope of the technical solutions of the embodiments of the present application.

1. A method of displaying a sound effect, comprising:
receiving a first operation that is input to a target audio file; and
displaying a sound effect display interface corresponding to the target audio file in response to the first operation;
wherein the sound effect display interface comprises: a cover image corresponding to the target audio file, a sound wave display element and a quasi-gyroscope; wherein the sound wave display element is an annular surface arranged along an edge of the cover image, which is used to expand to an area where the cover image is located according to a preset sound attribute of the target audio file to form a sound waveform corresponding to the preset sound attribute of the target audio file; the quasi-gyroscope comprises at least two light rings rotating along rotational axes in preset mode, and the rotational axes of the at least two light rings are all symmetric axes located within a plane where the cover image is located, and the rotational axes of the at least two light rings intersect at a geometric center of the cover image.

2. The method according to claim 1, wherein the quasi-gyroscope is displayed on a first layer of the sound effect display interface, the sound wave display element is displayed on a second layer of the sound effect display interface, and the cover image is displayed on a third layer of the sound effect display interface; and
the first layer is located on the second layer, and the second layer is located on the third layer.

3. The method according to claim 2, further comprising:
fuzzifying the sound wave display element.

4. The method according to claim 2, wherein the display of the sound effect display interface corresponding to the display the target audio file comprises:
generating a first sequence of frames corresponding to the quasi-gyroscope, wherein rotation positions of the light rings in various image frames in the first sequences of frames vary sequentially;
playing circularly the first sequence of frames on the first layer to display the sound effect display interface corresponding to the target audio file.

5. The method according to claim 2, wherein the sound effect display interface further comprises: a fourth layer under the third layer and a fifth layer under the fourth layer;
wherein the fourth layer is used to display a border of a first pattern, the fifth layer is used to display a border of a second pattern; both the first pattern and the second pattern are similar patterns to the cover image, and geometric centers of the first pattern and the second pattern and the geometric center of the cover image are located at the same point, an area of the first pattern is greater than an area of the cover image, and an area of the second pattern is greater than the area of the first pattern.

6. The method according to claim 5, further comprising:
fuzzifying a border of the first pattern and a border of the second pattern.

7. The method according to claim 5, further comprising:
acquiring a deflection angle of the sound effect display interface, which is an angle between a direction perpendicular to the sound effect display interface and the gravity direction; and
controlling the first layer, the second layer, the third layer, the fourth layer, and the fifth layer to deflect in corresponding deflection ranges according to the deflection angle, respectively.

8. The method according to claim 5, wherein the sound effect display interface further comprises: a sixth layer under the fifth layer, a seventh layer under the sixth layer, and an eighth layer under the seventh layer; and
the sixth layer is used to display a dot matrix image, the seventh layer is used to display streamer image, the eighth layer is used to display a grid image, the dot matrix image is a projection image of a three-dimensional matrix; the streamer image comprises a plurality of streamer lines propagating along edges of grids in the grid image, and the grid image comprises grids formed by the intersection of a plurality of horizontal lines and a plurality of vertical lines.

9. The method according to claim 8, wherein the displaying of the sound effect display interface corresponding to the display the target audio file comprises:
generating a second sequence of frames corresponding to the streamer image, wherein positions of the streamer lines in various image frames in the second sequences of frames vary sequentially; and
playing circularly the second sequence of frames on the seventh layer to display the sound effect display interface corresponding to the target audio file.

10. The method according to claim 1, wherein a color in a first position of the sound wave display element is a first color, and a color in a second position of the sound wave display element is a second color; and
a color of the sound wave display element varies gradually from the first color to the second color between the first position and the second position of the sound wave display element.

11. The method according to claim 10, wherein, before the displaying of the sound effect display interface corresponding to the target audio file, the method further comprises:
acquiring an average color value of various pixels of the cover image;
converting the average color value into a color in an HSV color space to obtain a basic color; and
determining the first color, the second color, and a background color of the sound effect display interface based on the basic color.

12. The method according to claim 11, wherein the determining the first color according to the basic color comprises:
determining that a hue of the first color is the same as that of the basic color;
determining that a saturation of the first color is the same as that of the basic color if a saturation of the basic color is greater than or equal to a threshold saturation; and determining that the saturation of the first color is a sum of the saturation of the basic color and a preset saturation if a saturation of the basic color is less than the threshold saturation; and
determining a value of the first color as a maximum value.

13. The method according to claim 11, wherein the determining the second color according to the basic color comprises:
determining that a hue of the second color is a sum of a hue of the basic color and a preset hue;
determining that a saturation of the second color is the same as that of the basic color if a saturation of the basic color is greater than or equal to a threshold saturation; and determining that the saturation of the second color is a sum of the saturation of the basic color and a preset saturation if a saturation of the basic color is less than the threshold saturation; and
determining a value of the second color as a maximum value.

14. The method according to claim 11, wherein the determining the background color according to the basic color comprises:
determining that a hue of the background color is the same as that of the basic color;
determining that a saturation of the background color is the same as that of the basic color if a saturation of the basic color is greater than or equal to a threshold saturation; and determining that the saturation of the background color is a sum of the saturation of the basic color and a preset saturation if a saturation of the basic color is less than the threshold saturation; and
determining a value of the background color is a difference between a value of the basic color and a target value, wherein the target value is a value corresponding to a value range to which the value of the basic color belongs, and the value corresponding to the value range is positively correlated with the central value of the value range.

15. The method according to claim 10, wherein the first position and the second position are two respective intersection positions of a target line and the sound wave display element; the target line is a line in a first plane, which passes through the geometric center of the sound wave display element and has a preset angle with a horizontal direction.

16. A terminal device, comprising:
a receiving unit configured to receive a first operation that is input to a target audio file; and
a display unit configured to display a sound effect display interface corresponding to the target audio file in response to the first operation;
wherein the sound effect display interface comprises: a cover image corresponding to the target audio file, a sound wave display element and a quasi-gyroscope; wherein the sound wave display element is an annular surface arranged along an edge of the cover image, which is configured to expand to an area where the cover image is located according to a preset sound attribute of the target audio file to form a sound waveform corresponding to the preset sound attribute of the target audio file; the quasi-gyroscope comprises at least two light rings rotating along rotational axes in a preset mode, and the rotational axes of the at least two light rings are all symmetric axes located within a plane where the cover image is located, and the rotational axes of the at least two light rings intersect at a geometric center of the cover image.

17. An electronic device, comprising: a memory configured to store a computer program and a processor configured to enable the electronic device to perform the method of displaying the sound effect in claim 1 upon calling and executing the computer program.

18. A computer-readable storage medium, wherein the computer-readable storage medium has a computer program stored thereon, and the computer program enables a computing device to perform the method of displaying the sound effect in claim 1 upon the computer program being executed by the computing device.

19. A computer program product, which enables a computer to perform the method of displaying the sound effect in claim 1 upon the computer program product being executed in the computer.
